(19) United States
(12) Patent Application Publication
(10) Pub. No.: US 2026/0031704 A1
(43) Pub. Date: Jan. 29, 2026

(54) ASYMMETRICAL HYBRID DC-DC CONVERTER

(71) Applicant: EPIC Microsystems Inc., Santa Clara, CA (US)

(72) Inventor: Nien Hui Kung, San Jose, CA (US)

(21) Appl. No.: 19/345,894

(22) Filed: Sep. 30, 2025

Related U.S. Application Data
(63) Continuation-in-part of application No. 19/258,638, filed on Jul. 2, 2025.
(60) Provisional application No. 63/667,998, filed on Jul. 5, 2024.

(51) Int. Cl. H02M 1/00; H02M 3/158

(52) U.S. Cl. CPC H02M 1/0095; H02M 3/158

(57) ABSTRACT

Systems for hybrid DC-DC voltage conversion are disclosed. One aspect includes an electrical circuit configured to perform a DC-DC voltage conversion between an input voltage and an output voltage. The electrical circuit includes a first electrical network that includes seven switching transistors and two flying capacitors, and a second electrical network that includes six switching transistors and one flying capacitor. The first electrical network and the second electrical network may be interconnected at least at each of an input node, an output node, and a switching node. Two switching transistors of the six switching transistors in the second electrical network may further connect the first electrical network and the second electrical network. The electrical circuit may include a magnetic reactive component connected between the switching node and the output node. The DC-DC voltage conversion may involve a repeating cycle of six distinct switching system states.

This application is a continuation-in-part of U.S. patent application Ser. No. 19/258,638, filed Jul. 2, 2025, titled “Asymmetrical Hybrid DC-DC Converter,” the disclosure of which is incorporated by reference herein in its entirety. That application claims the priority benefit of U.S. Provisional Patent Application Ser. No. 63/667,998, filed on Jul. 5, 2024, titled “Multiple Asymmetrical Current Path Hybrid Converter with Dynamic Flycap,” the disclosure of which is incorporated by reference herein in its entirety.

### BACKGROUND

### Technical Field

The systems and methods described herein relate to hybrid electrical circuits that are configured to implement power-efficient, high-voltage DC to DC conversion.

### Background Art

The need for more electrical power in current applications has pushed the design of power converters towards its limits. From a small gadget like a smart watch to the big room of a data center, power conversion is used everywhere. Generally speaking, the main sources of electrical power are the “grid” (110V/60 Hz) and the “battery” (1.2V-18V). In most applications, electrical power needs to be converted from a first voltage level to a second voltage level. For example, 110V/60 Hz AC power sourced from the electrical grid may need to be converted to 5V DC power. With ever-increasing electrical power consumption in our lives, efficient power conversion techniques are important to implement.

Power conversion devices with low conversion efficiency may generate heat due to the associated inefficient power conversion. A smart watch, phone, laptop, tablet, or any other personal computing device running at a temperature of 60 degrees Celsius is not a comfortable gadget for a user. A server room of a data center with an ambient temperature of 40 degrees Celsius is also an uncomfortable environment. For years, power conversion efficiency has been an important feature of the electrical power conversion process, and is especially important in today's day and age.

Electrical power conversion is achieved with electrical converters. Based upon input and output time-dependent current/voltage, there are 4 basic types of converters: AC to AC, AC to DC, DC to DC, and DC to AC. They cover all combinations between alternating current (AC) and constant/direct current (DC) conversion. All battery applications (e.g., mobile phones, tablets, laptops, etc.) use DC to DC converters for inside supply rails and AC to DC converters for charging the respective rechargeable battery from a wall adapter. While a high efficiency power converter helps keep the devices cool, the battery also needs to be charged fast, with more power, from an AC/DC adapter. This requires a high charging current through the adapter cable. The associated heating limits the current through the cable to a maximum of 3A. However, at such input current, the battery cannot charge fast enough in a short time.

In order to provide high current for charging but low current through the cable of the adapter, the input voltage of the converter (or output voltage of the adapter) needs to be increased. This requires a high input voltage DC/DC converter to supply the internal rails and a high output voltage AC/DC converter to supply the battery charging. A typical such DC/DC converter has 16V-28V/3A as input voltage, (coming through a cable from a wall adaptor) and 4.5V/10A-20A as output (the battery) voltage. One goal of power conversion is to keep handheld devices comfortably cool for a user.

The current generation of AI-based computing systems require a different power delivery system. The microprocessors of an AI-based computing system might need up to 1000A at 0.6V Such AI-based computing systems may populate data centers. The required power cannot be delivered by a battery; such power is sourced directly from the industrial grid through one or more conversion stages. The first is almost always an AC/DC conversion from 110V AC to 48V DC. From 48V down to 0.6V there are a few conversion stages, done by DC/DC converters. Some of these DC voltage converters are high voltage converters, while some are low voltage converters. Therefore, a high voltage DC/DC converter will satisfy both battery and grid supply systems.

Such converters are important in today's power management systems. Existing power conversion systems such as buck converters are vulnerable to power loss. Buck converters can generate a lot of current but with a power conversion efficiency no greater than 85%. The power efficiency of these systems can be increased by splitting the output into multiple channels (e.g., 100 channels) connected in parallel, with each channel supplying a relatively small amount of current. Because each channel requires an inductor, a printed circuit board (PCB) area occupied by such a system will be prohibitive. Other approaches use charge-pump converters (with a fixed conversion ratio (CR)). Although charge-pump converters can reach 99% efficiency, they are not used for output currents in excess of 2A. Hence, for the new generation of power-hungry systems, contemporary approaches that use buck converters or charge-pump converters are not suitable.

### SUMMARY

Aspects of the invention are directed to electrical circuits configured to implement power-efficient DC-to-DC power conversion. One aspect includes an electrical circuit configured to perform a DC-DC voltage conversion between an input voltage Vᵢₙ and an output voltage Vₒᵤₜ. The electrical circuit may be comprised of a first electrical network that includes seven switching transistors and two flying capacitors. The electrical circuit may also include a second electrical network that includes six switching transistors and one flying capacitor.

In an aspect, the first electrical network and the second electrical network are interconnected at least at each of an input node associated with the input voltage, an output node associated with the output voltage, and a switching node. In an aspect, two switching transistors of the six switching transistors in the second electrical network further connect the first electrical network and the second electrical network.

The electrical circuit may also include a magnetic reactive component connected between the switching node and the output node.

In an aspect, the DC-DC voltage conversion involves a repeating cycle of six distinct switching system states. Each switching system state may be associated with a distinct electric current path through the electrical circuit.

In an aspect, the magnetic reactive component is included in a current path from the input node to the output node. A direct path between the input node and the output node may include at least one switching transistor. Any current path between the input node and the switching node may include at least one flying capacitor of the flying capacitors. In an aspect, there is at least one switching transistor connected directly to the output node.

In one aspect, the six distinct switching system states are comprised of a first magnetization system state, a demagnetization system state, a second magnetization system state, the demagnetization system state, a third magnetization system state, and the demagnetization system state.

In an aspect, at the end of the sixth switching system state, a voltage on each flying capacitor is substantially equal to a voltage on the flying capacitor at a beginning of the first system state. This equality may be established by a feedback control circuit.

In an aspect, each system state is associated with a combination of each of the switching transistors being either in an on state or an off state.

In an aspect the input voltage and the output voltage are related as Vᵢₙ≥3Vₒᵤₜ.

In an aspect, any combination of the first electrical network and the second electrical network includes any combination of one or more switching transistors to provide a modified electrical circuit, where the input voltage and the output voltage for the modified electrical circuit are related as Vᵢₙ≥Vₒᵤₜ. Other embodiments of the electrical circuit are configured to implement different input/output voltage inequalities.

In an aspect, the magnetic reactive component is an inductor. In another aspect, the magnetic reactive component is any of a transformer, a coupled inductor, or a TLVR inductor configured to enhance a load transient response of a load connected to the output node.

An aspect includes a parallel connection of a plurality of electrical circuits to provide a modified electrical circuit configured to further provide a higher electric current to a load as compared an electric current provided by the electrical circuit operating singularly.

Other embodiments include an electrical circuit configured to perform a DC-DC voltage conversion between an input voltage Vᵢₙ and an output voltage Vₒᵤₜ, the electrical circuit comprising a first electrical network that includes seven switching transistors and two flying capacitors. The electrical circuit may include a second electrical network that includes four switching transistors and one flying capacitor. The first electrical network and the second electrical network may be interconnected at least at each of an input node associated with the input voltage, an output node associated with the output voltage, and a switching node. In an aspect, two switching transistors of the four switching transistors in the second electrical network further connect the first electrical network and the second electrical network. The electrical circuit may further include a magnetic reactive component connected between the switching node and the output node. In an aspect, the DC-DC voltage conversion involves a repeating cycle of four distinct switching system states. Each switching system state may be associated with a distinct electric current path through the electrical circuit.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a circuit diagram of a hybrid DC-DC converter.

FIG. 2 is a timing diagram depicting a plurality of electrical signals associated with an operation of a hybrid DC-DC converter.

FIG. 3 is a circuit diagram of a hybrid DC-DC converter depicting a magnetization state.

FIG. 4 is a circuit diagram of a hybrid DC-DC converter depicting a demagnetization state.

FIG. 5 is a circuit diagram of a hybrid DC-DC converter depicting a magnetization state.

FIG. 6 is a circuit diagram of a hybrid DC-DC converter depicting a magnetization state.

FIG. 7 is a state flow diagram depicting switching system state transitions between magnetization states and a demagnetization state.

FIG. 8 is a circuit diagram of a hybrid DC-DC converter.

FIG. 9 is a circuit diagram of a hybrid DC-DC converter.

FIG. 10 is a circuit diagram of a hybrid DC-DC converter.

FIG. 11 is a circuit diagram of a hybrid DC-DC converter.

FIG. 12 is a circuit diagram of a hybrid DC-DC converter.

FIG. 13 is a diagram depicting a hybrid DC-DC converter transitioning through four distinct switching system states.

FIG. 14 is a circuit diagram depicting a pair of parallel-connected hybrid DC-DC converters.

FIG. 15 is a circuit diagram of a hybrid DC-DC converter.

FIG. 16 is a circuit diagram of a hybrid DC-DC converter.

FIG. 17 is a circuit diagram of a hybrid DC-DC converter.

FIG. 18 is a circuit diagram of a hybrid DC-DC converter.

FIG. 19 is a circuit diagram of a hybrid DC-DC converter.

FIG. 20 is a circuit diagram of a hybrid DC-DC converter.

FIG. 21 is a circuit diagram depicting a pair of parallel-connected hybrid DC-DC converters.

FIGS. 22A and 22B are circuit diagrams depicting different hybrid regulator connection topologies.

FIG. 22C is a waveform diagram presenting load voltage transient response and load current waveforms.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code can be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Aspects of the systems and methods described herein are related to a hybrid, high-voltage DC-to-DC converter with increased efficiency. Unlike a traditional buck converter, with 2 high voltage FETs, where the output current closes through a single path (either from Vᵢₙ or from PGND), the hybrid DC-DC converters disclosed herein use multiple, low-voltage, stacked field-effect transistors (FETs) and multiple current paths through an inductor. This feature is achieved with a specific switching sequence. This switching sequence reduces the power loss and increases the efficiency of the hybrid DC-DC converter.

To satisfy an even higher input voltage requirement, the circuit topology can be extended to multiple current paths closing to a single inductor. One aspect includes 2 circuits with a total of 13 low-voltage FETs, one current path through the inductor, and one current path closing through one or more flying capacitors included in the circuit topology. The input voltage should satisfy condition Vᵢₙ≥3Vₒᵤₜ.

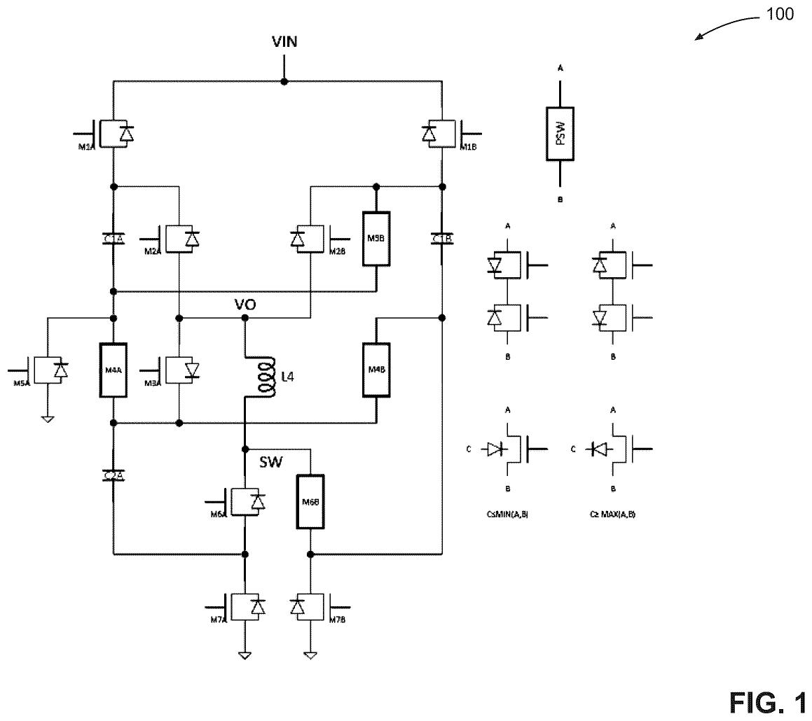

FIG. 1 is a circuit diagram of a hybrid DC-DC converter 100. As depicted, the hybrid DC-DC converter 100 includes an input node associated with an input voltage Vᵢₙ, an output node associated with an output voltage Vₒᵤₜ, and a switching node associated with a voltage V_{LX}. As depicted, hybrid DC-DC converter 100 includes the following components:
M1A-M7A and M1B-M7B are power NFETs (e.g., power switches).
C1A-C2A and C1B are flying capacitors.
L4 is an inductor, connected between V_{LX} and Vₒᵤₜ.
C_{OUT} is an output capacitor, connected between Vₒᵤₜ and a ground node, PGND (not depicted in FIG. 1).
An electrical load is connected between Vₒᵤₜ and PGND (not shown in FIG. 1). This electrical load may be any combination of a microprocessor, a resistor, a current source, etc.

In an aspect, components M1A-M7A, C1A, and C2A are included in a first electrical network. Components M1B, M2B, M5B-M7B and C1B may be included in a second electrical network. The first and second electrical networks may be connected at the input node, the output node, and the switching node. Further, components M3B and M4B are switching transistors, included in the second electrical network, that may be connected between the first electrical network and the second electrical network. In general, the switching transistors described herein may be any kind of power switch, such as NFETs, PFETs, bipolar switches, thyristors, triacs, gallium nitride (GaN) devices, etc. As depicted, hybrid DC-DC converter 100 includes inductor L4; this inductor is interchangeably referred to herein as “inductor L”.

In one aspect, one or more of the switching transistors in any combination of the first and second electrical networks are power switches with reverse blocking (PSW). Examples of PSWs include but are not limited to:
(a) A pair of devices with a back-to-back body diode with NMOSFET, PMOSFET, or related devices.
(b) An NMOSFET, with a body that is lower than or equal to the minimum of the drain and source.
(c) A PMOSFET, with a body that is higher than or equal to the maximum of the drain and source.
(d) A device without a body diode.
(e) A device with a switchable body terminal that selects the suitable level following (c) and (d) above.

Examples of PSW embodiments are depicted in FIG. 1.

In one aspect, switches M4A, M3B, M4B and M6B in hybrid DC-DC converter 100 are PSWs, as depicted in FIG. 1. The other switches in hybrid DC-DC converter 100 (e.g., M1A, M2A, etc.) can each be a single device (NMOSFET, PMOSFET, or other transistors) with a correct body diode direction. The other switches can each also be a device without a body diode.

In an aspect, the first electrical network and the second electrical network are interconnected at least at each of an input node associated with the input voltage, an output node associated with the output voltage, and a switching node SW, associated with a switching voltage V_{LX}.

In an aspect, an operation of hybrid DC-DC converter is associated with the following properties:
There is an inductor (i.e., inductor L) in a current path from Vᵢₙ to Vₒᵤₜ
There exists a direct path (only through switches) between Vₒᵤₜ and Vᵢₙ.
Any path between V_{LX} and Vᵢₙ includes at least one flying capacitor.
There is at least 1 power switch (i.e., switching transistor) connected directly to Vₒᵤₜ.

During operation of hybrid DC-DC converter 100, each of switching transistors M1A-M7A and M1B-M7B is either in an ON state or an OFF state, following a certain pattern/cycle. A cycle is determined by 6 switching system states, with each switching system data being determined by a switching state (i.e., ON/conducting state or OFF/non-conducting state) of each of switching transistors M1A-M7A and M1B-M7B. Each system state is associated with a specific combination of switching transistors M1A-M7A and M1B-M7B each being in an on (conducting) state or an off (non-conducting) state. A switching system state is either initiated by a clock signal and terminated by the falling edge of the T_{ON} signal, or, initiated by the falling edge of the T_{ON} signal and terminated by the clock signal. Both signals, clock, and T_{ON}, are controlled by a feedback loop which regulates the output voltage Vₒᵤₜ.

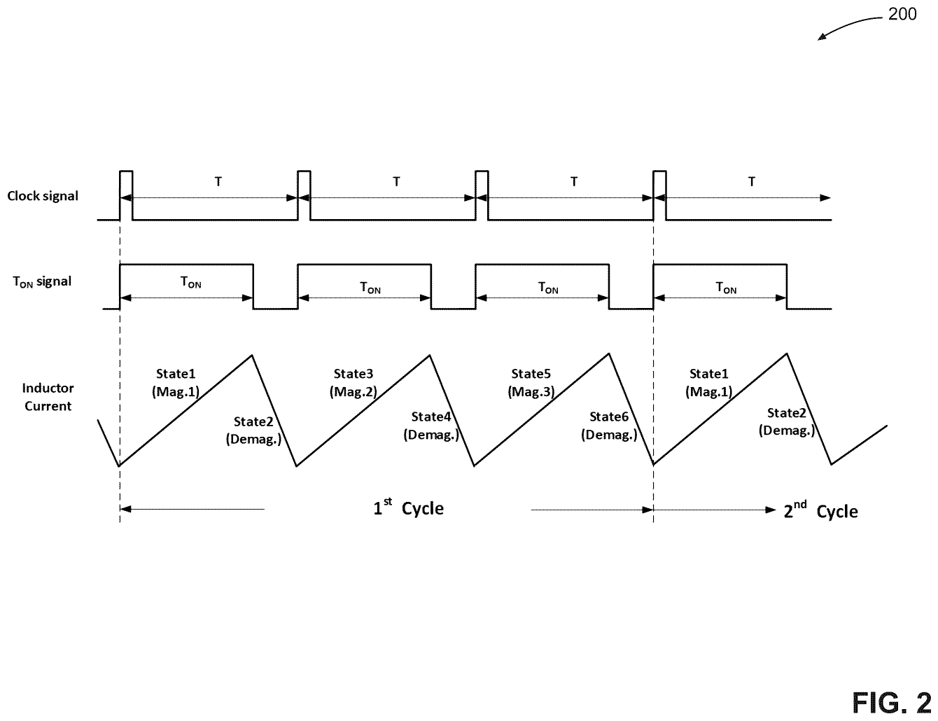

FIG. 2 is a timing diagram 200 depicting a plurality of electrical signals associated with an operation of hybrid DC-DC converter 100. Timing diagram 200 depicts electrical signal waveforms associated with the six distinct switching system states. A switching system state is either initiated by a clock signal and terminated by the falling edge of an associated T_{ON} signal, or, initiated by a falling edge of the T_{ON} signal and terminated by the clock signal. Both signals, clock (clk) and T_{ON}, are controlled by a feedback loop which regulates the output voltage. Timing diagram 200 also depicts a current waveform representing inductor current through inductor L versus time. As shown in the inductor current waveform, there are six distinct switching system states:
A first magnetization state (Magnetization1, or Mag1),
A first demagnetization state (Demagnetization1, or Demag1),
A second magnetization state (Magnetization2, or Mag 2),
A second demagnetization state (Demagnetization2, or Demag2).
A third magnetization state (Magnetization3, or Mag 3), and
A third demagnetization state (Demagnetization3, or Demag3).

A full sequence of the six switching system states (i.e., Mag1 Demag1, Mag2, Demag2, Mag3 and Demag3) constitutes one switching cycle. In one aspect, the demagnetization state may be the same for each demagnetization state in the switching cycle, and denoted by “Demag”. In other words, Demag1, Demag2 and Demag 3, may be the same state, Demag.

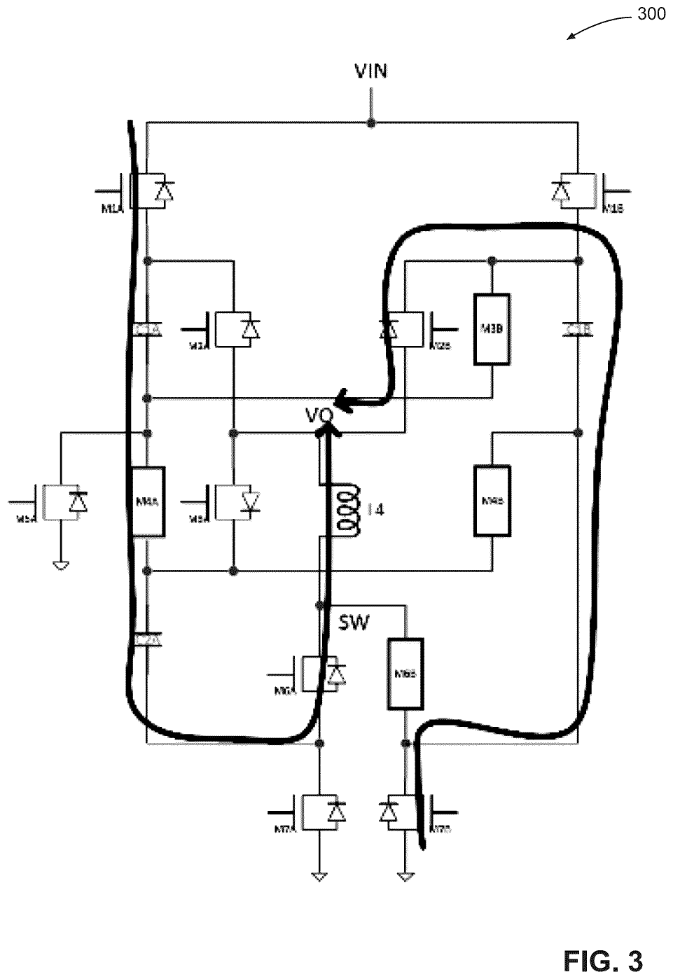

FIG. 3 is a circuit diagram of hybrid DC-DC converter 100 depicting a magnetization state 300. Magnetization state 300 is a switching system state (State 1) that may be associated with magnetization state Mag1, of hybrid DC-DC converter 100. In this magnetization state, the states of the switching transistors are:
ON: M1A, M4A, M6A, M2B, M7B
OFF: M2A, M3A, M5A, M7A, M1B, M3B, M4B, M6B

As a result of this configuration of ON/OFF switches and considering the voltages on each of the flying capacitors are near Vₒᵤₜ, the voltage on the inductor is:

$${V}_{L} = ( {V}_{in} - 3 {V}_{out} ) .$$

Because Vᵢₙ≥3Vₒᵤₜ, such a voltage is positive, and the inductor is magnetized. Hence, this State 1 is referred to as a “Magnetization1” state, or “Mag1”.

During the Mag1 switching system state (State 1), two distinct electrical current paths for electrical currents flowing in hybrid DC-DC converter 100 can be identified:
Path1: VIN→M1A→C1A→M4A→C2A→M6A→Inductor L→Vₒᵤₜ
Path2: PGND→M7B→C1B→M2B→Vₒᵤₜ

The electrical currents from these two electrical current paths gather into a “Multi Current Path” towards Vₒᵤₜ. Of these, one electrical current path closes through the inductor L and the other path goes directly to Vₒᵤₜ. A difference from a traditional buck converter is that the second path (i.e., Path2) does not exist for a traditional buck converter. This is one of the reasons that hybrid DC-DC converter 100 has better efficiency as compared to a traditional buck converter.

During this Magnetization1 phase of the inductor L, the flying capacitors change their states as well:
C1A is charged with ΔV1 by a fraction of the inductor current I_{L}_{₁}.
C2A is charged with ΔV2 by a fraction of the inductor current I_{L}_{₁}
C1B is discharged with ΔV1 by I_{CP}_{₁}

After the T_{ON} pulse elapsed the system changes the state. It goes to the next switching system state—State 2.

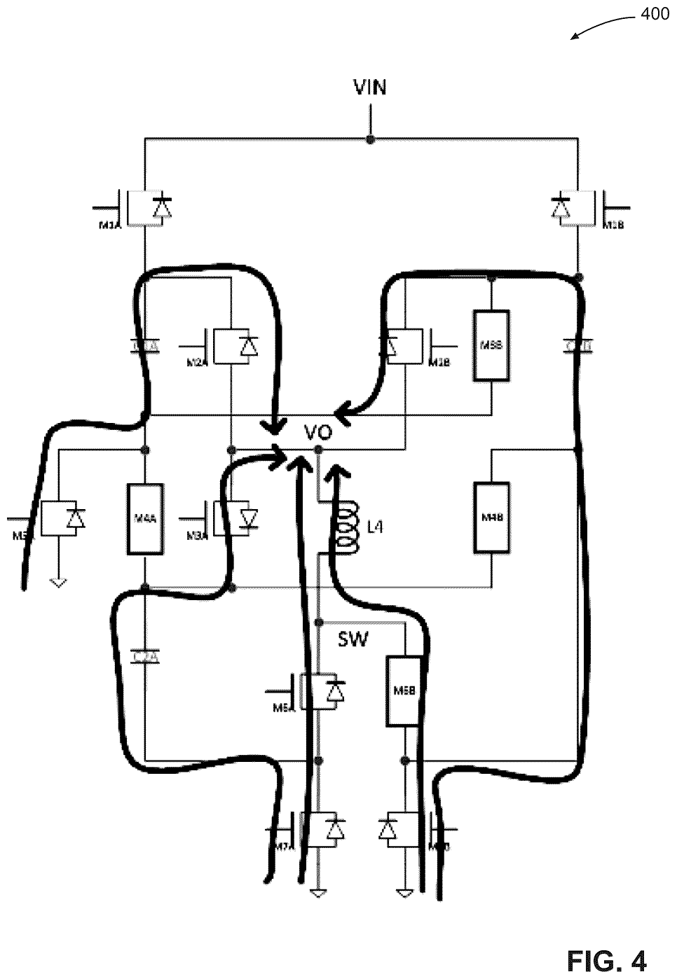

FIG. 4 is a circuit diagram of hybrid DC-DC converter 100 depicting a demagnetization state 400. Demagnetization state 400 is a switching system state (State 2) that may be associated with demagnetization state Demag1. In an embodiment, demagnetization state 400 is also associated with demagnetization states Demag2 and Demag3. In other words, for the hybrid DC-DC converter 100, switching system states Demag1, Demag2 and Demag3 are identical (i.e., Demag). In this demagnetization state, the states of the switching transistors are:
ON: M6A, M7A, M6B, M7B. (Options: M2A, M3A, M5A, M2B)
OFF: M1A, M4A, M1B, M3B, M4B.

The inductor voltage is:

$${V}_{L} = - {V}_{out} .$$

Because of the negative voltage, the inductor is demagnetized. Hence, this switching system state, “State 2”, is called a demagnetization state, or “Demag”.

During the Demag1 (Demag) switching system state, five distinct electrical current paths for electrical currents flowing in hybrid DC-DC converter 100 can be identified:
Path3: PGND→M7A→M6A→Inductor L→Vₒᵤₜ
Path4: PGND→M7B→M6B→Inductor L4 Vₒᵤₜ
Path3A (Same as Path8, described subsequently): PGND→M5A→C1A→M2A→Vₒᵤₜ
Path4A (Same as Path6, described subsequently): PGND→M7A→C2A→M3A→Vₒᵤₜ
Path3B (Same as Path2): PGND→M7B→C1B→M2B→Vₒᵤₜ

During this Demag phase, the flying capacitors C1A-C2A and C1B can be operated to keep their states. There is no current crossing these flying capacitors, so they maintain their respective voltages from the end of State 1. On the other hand, the flying capacitors can be operated to discharge to Vₒᵤₜ if Path3A, 3B, and 4A are ON.

When the next clock pulse arrives, the system goes into State 3, which is the next switching system state.

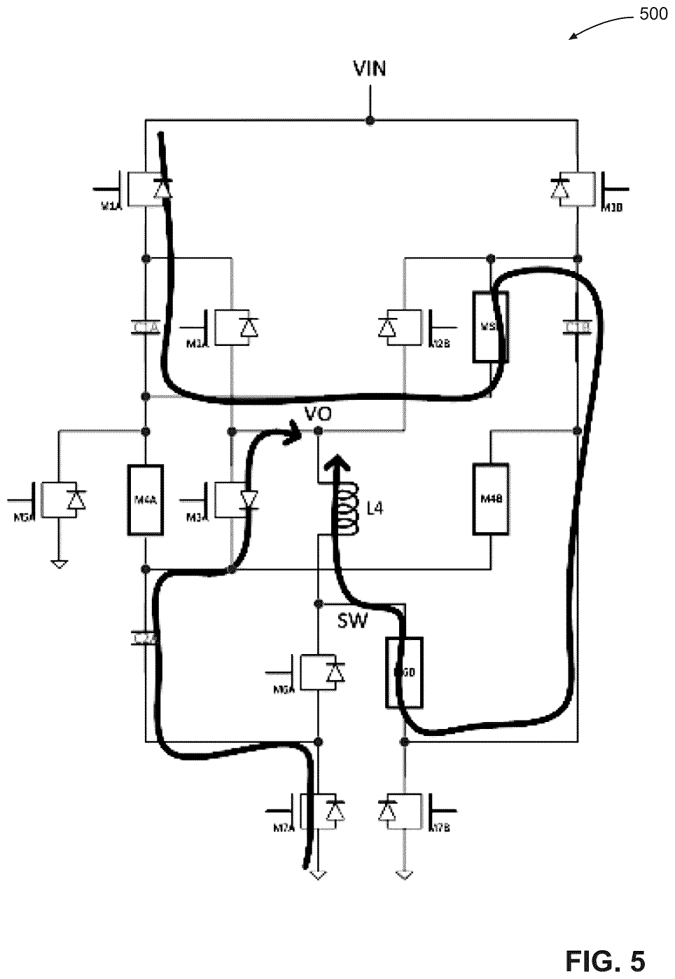

FIG. 5 is a circuit diagram of hybrid DC-DC converter 100 depicting a magnetization state 500. Magnetization state 500 is a switching system state (State 3) that may be associated with magnetization state Mag2. In this magnetization state, the states of the switching transistors are:
ON: M1A, M3A, M7A, M3B, M6B
OFF: M2A, M4A, M6A, M1B, M2B, M4B, M7B

During the Mag2 switching system state, two distinct electrical current paths for electrical currents flowing in hybrid DC-DC converter 100 can be identified:
Path5: Vᵢₙ→M1A→C1A→M3B→C1B→M6B→Inductor L→Vₒᵤₜ
Path6: PGND→M7A→C2A→M3A→Vₒᵤₜ

During this Mag2 phase of the inductor L, the flying capacitors change their states as well:
C1A is charged with ΔV1 by a fraction of the inductor current I_{L}_{₂}.
C1B is charged with ΔV2 by a fraction of the inductor current I_{L}_{₂}.
C2A is discharged with ΔV1 by I_{CP}.

The falling edge of the T_{ON} pulse triggers the end of State 3 and the start of State 4. In an aspect, State 4 is a demagnetization state, that is the same as the Demag State 2. During State 4, the inductor is demagnetized. At the next clock pulse, the system transitions from State 4 into State 5.

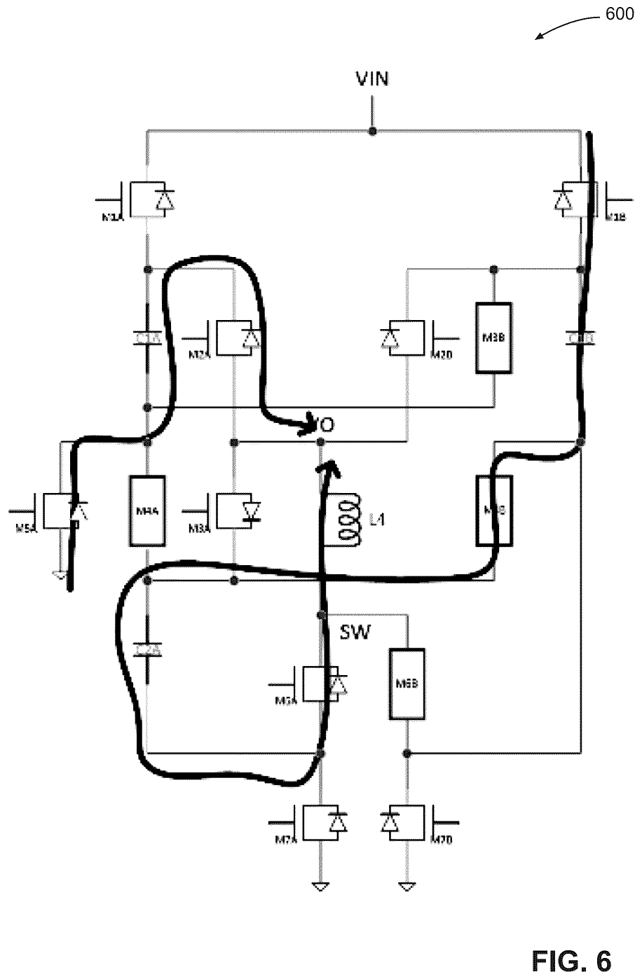

FIG. 6 is a circuit diagram of hybrid DC-DC converter 100 depicting a magnetization state 600. Magnetization state 600 is a switching system state (State 4) that may be associated with magnetization state Mag3 of hybrid DC-DC converter 100. In this magnetization state, the states of the switching transistors are:
ON: M2A, M5A, M6A, M1B, M4B
OFF: M1A, M3A, M5A, M7A, M2B, M3B, M6B, M7B

During the Mag3 switching system state, two distinct electrical current paths for electrical currents flowing in hybrid DC-DC converter 100 can be identified:
Path7: Vᵢₙ→M1B→C1B→M4B→C2A→M6A→Inductor L→Vₒᵤₜ
Path8: PGND→M5A→C1A→M2A→Vₒᵤₜ

During this Mag3 phase of the inductor L, the flying capacitors change their states as well:
C1B is charged with ΔV1 by a fraction of the inductor current I_{L}_{₃}.
C2A is charged with ΔV2 by a fraction of the inductor current I_{L}_{₃}.
C1A is discharged with ΔV1 by I_{CP}_{₃}.

The falling edge of the T_{ON} pulse triggers the end of State 5 and the start of State 6. In an aspect, State 6 is a switching system state that is a demagnetization state (Demag), identical to State 2 and State 4. During this state, the inductor is demagnetized as described above. The end of State 6 coincides with the end of a cycle of switching system states.

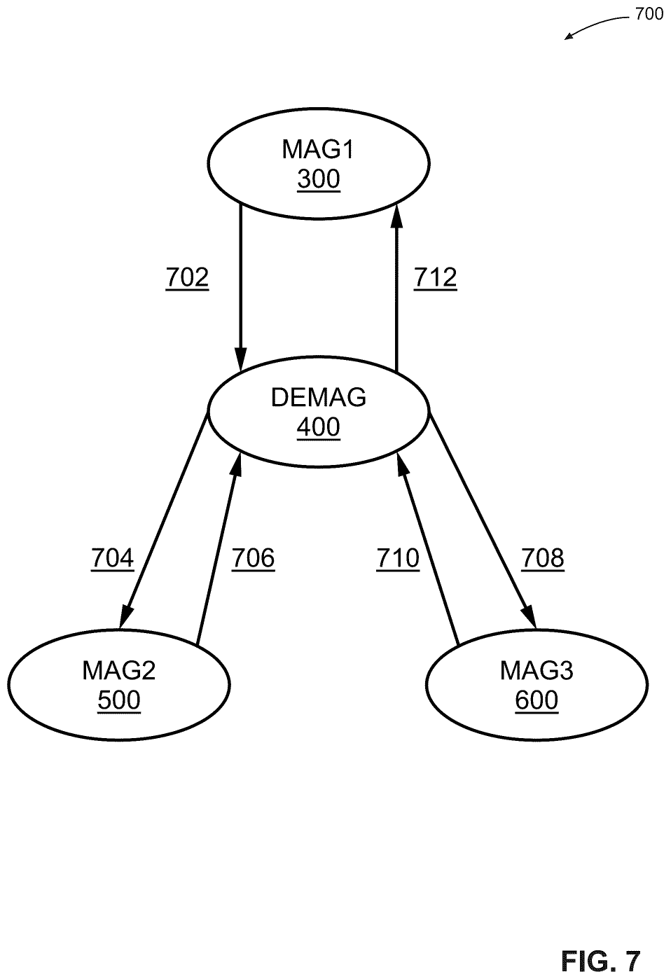

FIG. 7 is a state flow diagram 700 depicting switching system state transitions between magnetization states and a demagnetization state for hybrid DC-DC converter 100. Starting at Mag1 state 300 (State 1), the system transitions 702 to Demag state 400 (State 2). After the Demag state 400, the system transitions 704 to the Mag2 state 500 (State 3). Next, the system transitions 706 from Mag2 state 500 to the Demag state 400 (State 4). The system then transitions 708 from Demag state 400 to Mag3 state 600 (State 5). Finally, the system transitions 710 from the Mag3 state 600 to the Demag state 400 (State 6). The end of State 6 marks the end of a single switching system state cycle. After the Demag state 400 (State 6), the system transitions back 712 to the Mag1 state 300 to start a new switching system state cycle. For proper system operation, at the end of the switching system state cycle, the voltages on the flying capacitors should be equal to the respective voltage values at the beginning of the cycle. This very critical condition, to keep the flying capacitors well balanced, is achieved by the control feedback loop. In an aspect, a switching system phase transitions to a subsequent switching system phase based on the input clock signal.

There are three reasons such a hybrid architecture of hybrid DC-DC converter offers an increased efficiency versus other topologies:

Because V_{LX}=(Vᵢₙ−2Vₒᵤₜ) during magnetization, the inductor has a low current ripple, and core losses are very low. In contrast, a buck converter has V_{LX}=Vᵢₙ−Vₒᵤₜ. As a result of this, the buck converter is associated with more ripple current and more core losses on the inductor than the hybrid DC-DC converter embodiments described herein.

Direct current resistance (DCR) losses on the inductor are proportional to I_{L}². Unlike a buck converter where, I_{L}=I_{LOAD}, the hybrid DC-DC converter 100 includes a smart switching sequence that enables hybrid DC-DC converter 100 to supply the current to the load via two paths: through the inductor, and directly to Vₒᵤₜ while bypassing the inductor. Lowering the inductor current reduces the DCR losses compared with a buck converter.

There are other advantages offered by such a topology:
It allows the use of low-voltage FETs as switching transistors for high voltage input.
The circuit topology allows the circuit to be scaled to an arbitrary division coefficient, n. This might be necessary either when the input voltage is higher or when a lower voltage on the switching node (V_{SW}=(Vᵢₙ−N*Vₒᵤₜ)) is needed. This adjustment of the schematic can be done just by inserting more FETs in the top section of the circuit associated with hybrid DC-DC converter 100. The advantage of keeping the switching (SW) node at low voltage (Vᵢₙ−N*Vₒᵤₜ) is still maintained with all the advantages discussed herein.

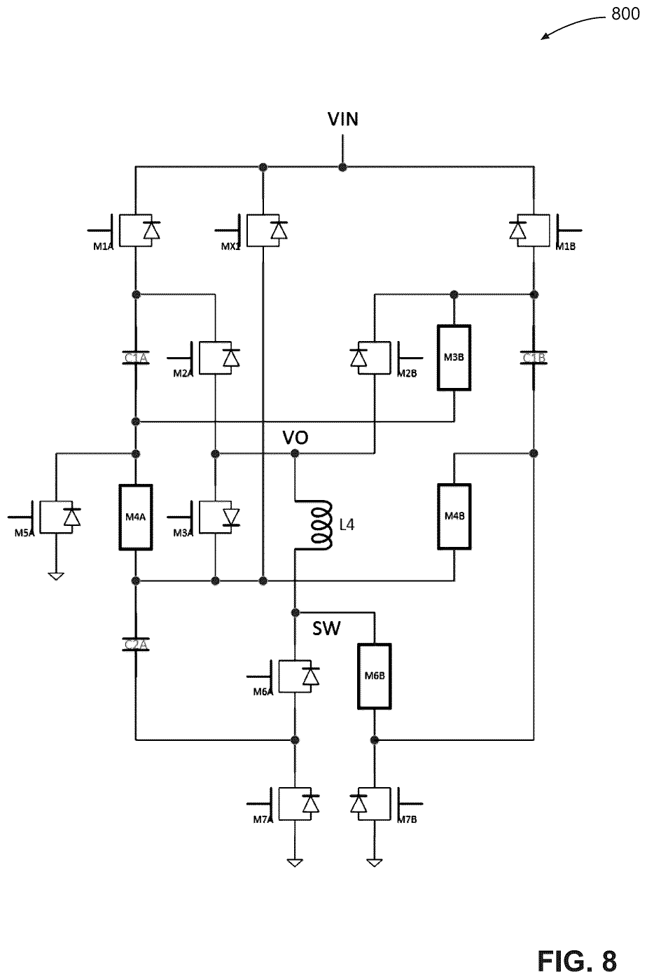

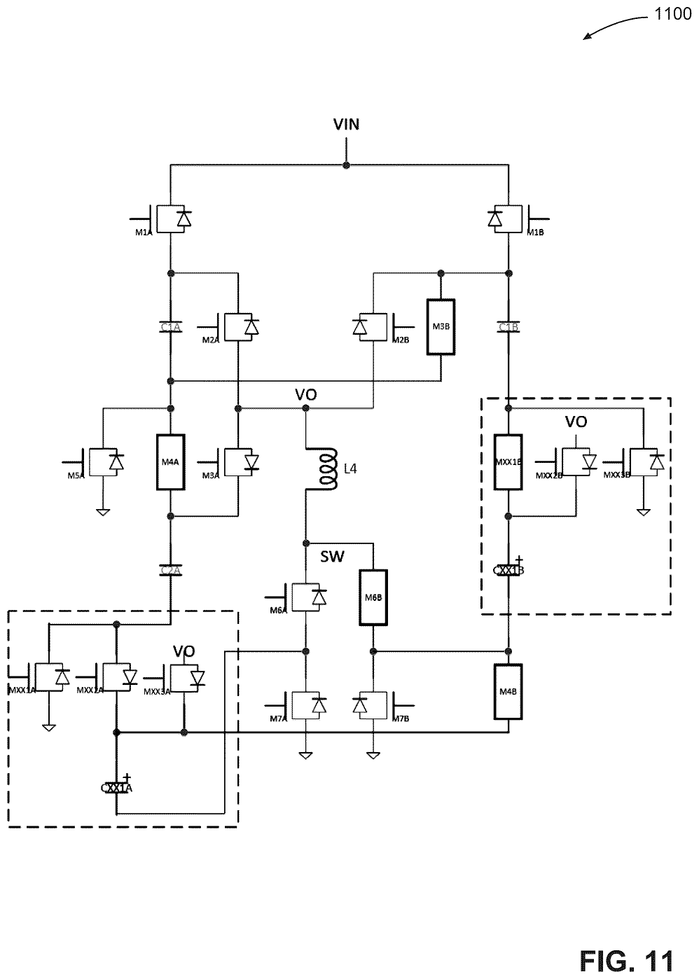

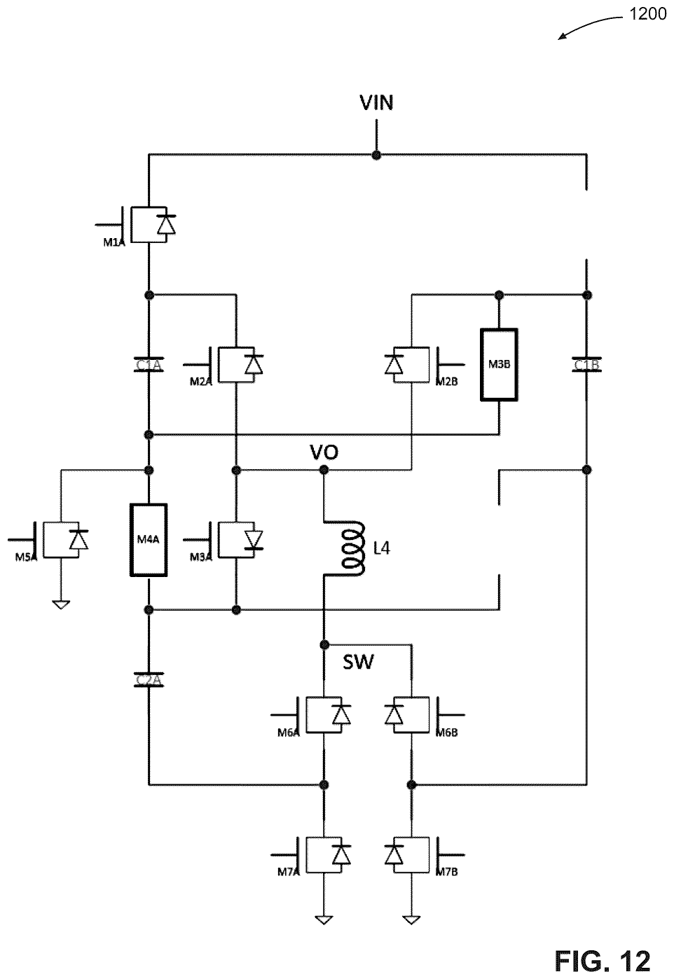

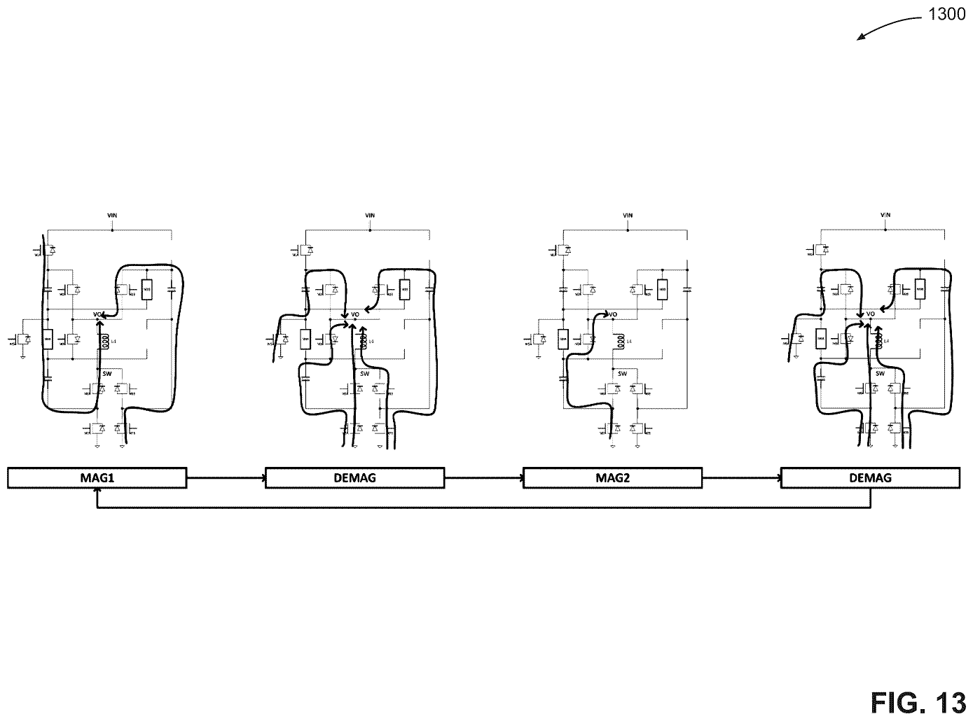

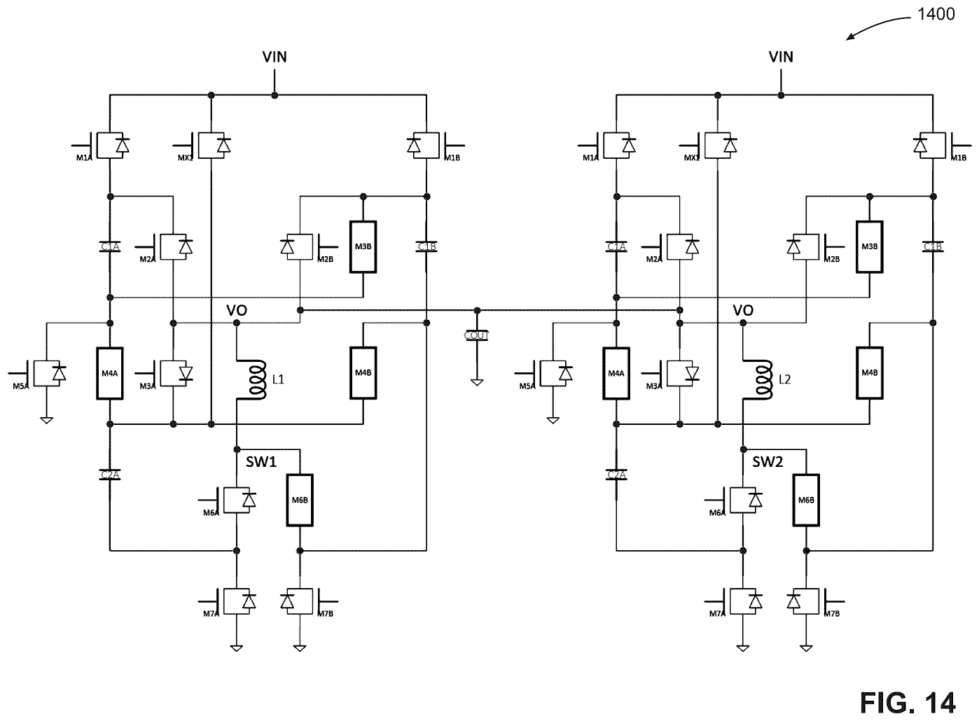

The functionality of the schematic from FIG. 1 is limited to relatively high voltages, e.g., Vᵢₙ>3Vₒᵤₜ. There are three ways to extend the functionality of this schematic by making adjustments/modifications to the circuit topology of hybrid DC-DC converter 100:
A) Scaling down the input voltage, from Vᵢₙ>3Vₒᵤₜ to Vᵢₙ>Vₒᵤₜ. Examples of such circuit topologies are presented in FIGS. 8, 9, 10, and 11.
B) Scaling up the input voltage, from Vᵢₙ>3Vₒᵤₜ to an even higher Vᵢₙ>nVₒᵤₜ can be done with another extension of the circuit topology associated with hybrid DC-DC converter 100, as shown in FIG. 11.
C) Reducing a number of switching transistors and associated control states to achieve similar performance as hybrid DC-DC converter 100, as depicted in FIGS. 12 and 13.
D) Scaling up the output current needed by an artificial intelligence (AI) chip, as shown in FIG. 14.

FIG. 8 is a circuit diagram of a hybrid DC-DC converter 800. Hybrid DC-DC converter 800 is a variation of hybrid DC-DC converter 100. As shown in FIG. 8, switching transistor MX2 is connected between the input node and a terminal of capacitor C2A in the circuit topology associated with hybrid DC-DC converter 100, to get the circuit topology of hybrid DC-DC converter 800. This increase in complexity leaves the voltages of flying capacitors unchanged for the wide Vᵢₙ range. This is particularly important when the Vᵢₙ changes by flying between Vᵢₙ˜Vₒᵤₜ and Vᵢₙ>3Vₒᵤₜ. In one aspect, hybrid DC-DC converter 800 supports a mode of operation 3Vₒᵤₜ≥Vᵢₙ≥2Vₒᵤₜ.

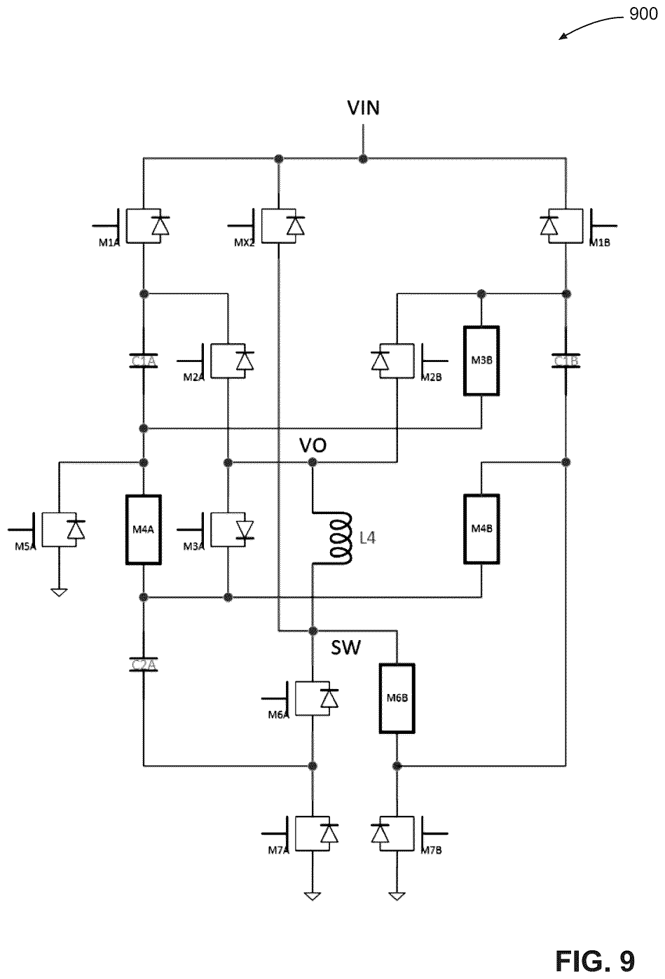

Other hybrid topologies (e.g., the topologies presented in FIGS. 9-11) may include a change in flying capacitor pre-bias voltages to work properly. However, different switching sequences over a cycle, (similar to that described herein for the case Vᵢₙ≥3Vₒᵤₜ) can be applied for each of the ranges 3Vₒᵤₜ≥Vᵢₙ≥2Vₒᵤₜ, 2Vₒᵤₜ≥Vᵢₙ≥Vₒᵤₜ, and Vᵢₙ≥Vₒᵤₜ, respectively. This extended dynamic mode of operation from Vᵢₙ>Vₒᵤₜ up to Vᵢₙ>3Vₒᵤₜ with high power efficiency makes the circuit topologies presented in FIGS. 8-11 very useful.

FIG. 9 is a circuit diagram of a hybrid DC-DC converter 900. As shown in FIG. 9, switching transistor MX2 is connected between the input node and the switching node of hybrid DC-DC converter 100, to get the circuit topology of hybrid DC-DC converter 900. In one aspect, hybrid DC-DC converter supports modes of operation 2Vₒᵤₜ≥Vᵢₙ≥Vₒᵤₜ, and Vᵢₙ>Vₒᵤₜ.

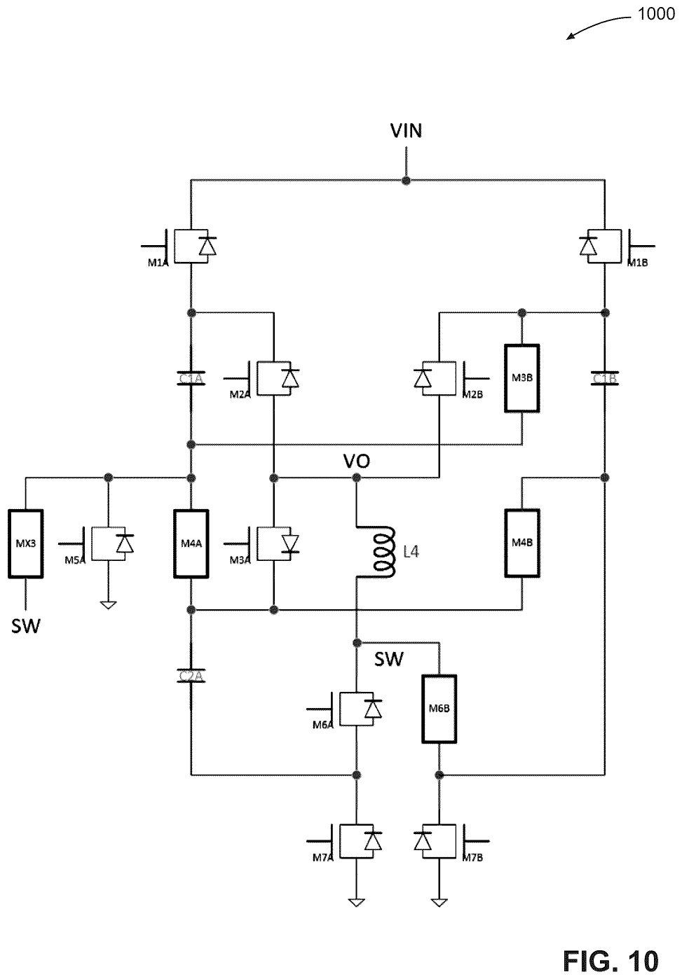

FIG. 10 is a circuit diagram of a hybrid DC-DC converter 1000. Hybrid DC-DC converter 1000 is based on the circuit topology of hybrid DC-DC converter 100, where the circuit topology of hybrid DC-DC converter 1000 includes additional switching transistor MX3 connected to switching transistor M5A. In one aspect, hybrid DC-DC converter 1000 supports a mode of operation 3Vₒᵤₜ≥Vᵢₙ≥2Vₒᵤₜ.

FIG. 11 is a circuit diagram of a hybrid DC-DC converter 1100. Hybrid DC-DC converter 1100 is based on the circuit topology of hybrid DC-DC converter 100, where the circuit topology of hybrid DC-DC converter 1100 includes additional switching transistors MXX1A, MXX2A, and MXX3A, and capacitor CXX1A included in the first electrical network of hybrid DC-DC converter 100. In one aspect, hybrid DC-DC converter 1100 supports a mode of operation Vᵢₙ≥4Vₒᵤₜ.

FIG. 12 is a circuit diagram of a hybrid DC-DC converter 1200. Hybrid DC-DC converter 1200 is a variant of hybrid DC-DC converter 100, with two switching transistors (e.g., M1B and M4B) removed from the circuit topology of hybrid DC-DC converter 100. Apart from the reduced complexity, a switching cycle associated with hybrid DC-DC converter 1200 is comprised of four switching system states (instead of the six switching system states associated with hybrid DC-DC converter 100).

FIG. 13 is a diagram 1300 depicting hybrid DC-DC converter 1200 transitioning through four distinct switching system states 1300. FIG. 1300 also shows corresponding current paths through hybrid DC-DC converter for each switching system state. As shown in FIG. 13, the four switching system states associated with the operation of hybrid DC-DC converter 1200 are a Mag1 state, a Demag state, a Mag2 state, and the Demag state. In this case (just as for the operation of hybrid DC-DC converter 100), the demagnetization state is consistent over each cycle.

FIG. 14 is a circuit diagram depicting a pair of parallel-connected hybrid DC-DC converters 1400. In an aspect, if higher load current capacity is required, multiple circuits of hybrid DC-DC converter 100 may be connected in parallel. For example parallel connection 1400 includes two instances of hybrid DC-DC converter 100 connected in a parallel configuration. In one aspect, multiple such instances of hybrid DC-DC converter 100 can be parallel-connected as needed. Such a multi-phase system has the same input Vᵢₙ and the same output Vₒᵤₜ. The overall current will be the sum of the current generated by each phase. In alternative embodiments, the parallel connection can be comprised of circuits that include hybrid DC-DC converter configurations 800-1200.

In some embodiments, the inductor L4 (which is a magnetic reactive component) in hybrid DC-DC converter 100, 800, 900, 1000, 1100 or 1200 may be replaced by an alternative magnetic reactive component such as a transformer, a coupled inductor, or a TLVR inductor. The inductors L1 and L2 (magnetic reactive components) in parallel-connected hybrid DC-DC converters 1400 may each be replaced by an alternative magnetic reactive component such as a transformer, a coupled inductor, or a TLVR inductor. The alternative magnetic reactive component(s) may be configured to enhance a load transient response of a load connected to an output node of any of the hybrid DC-DC converters described herein (e.g., hybrid DC-DC converter 100, 800, 900, 1000, 1100 or 1200). In an aspect, the load transient response may be a load voltage transient response.

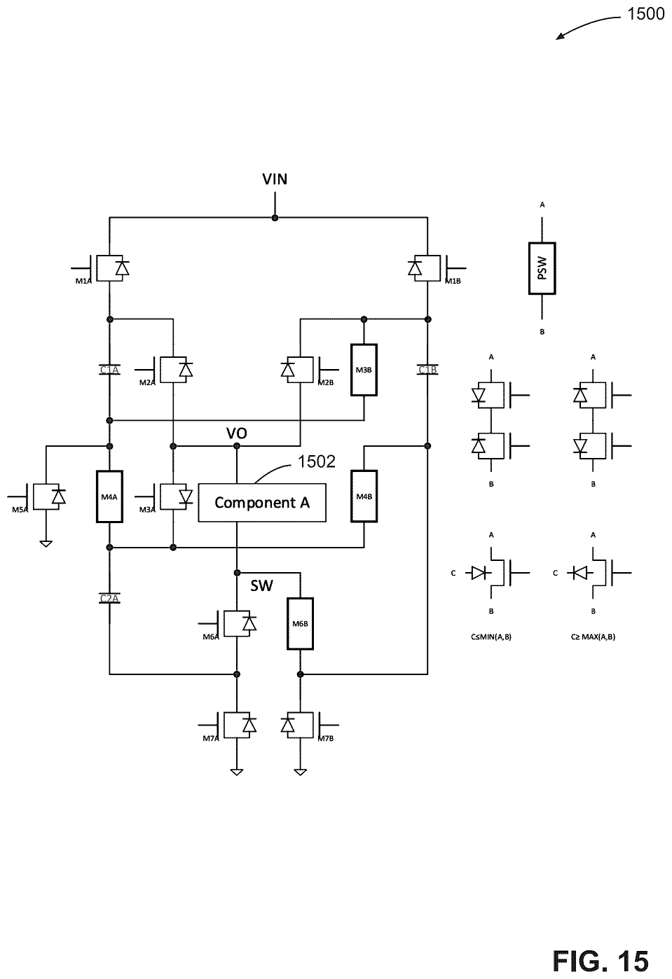

FIG. 15 is a circuit diagram of a hybrid DC-DC converter 1500. Hybrid DC-DC converter 1500 is essentially hybrid DC-DC converter 100, with inductor L4 replaced by magnetic reactive component A 1502. The functionality of hybrid DC-DC converter 1500 (e.g., performance parameters such as current paths, voltages, etc.) is similar to that of hybrid DC-DC converter 100. In an aspect, magnetic reactive component A 1502 is any of a transformer, a coupled inductor, or a TLVR inductor, configured to enhance a load transient response of a load connected to output node VO of hybrid DC-DC converter 1500. The output node VO of hybrid DC-DC converter 1500 may be associated with an output voltage Vₒᵤₜ.

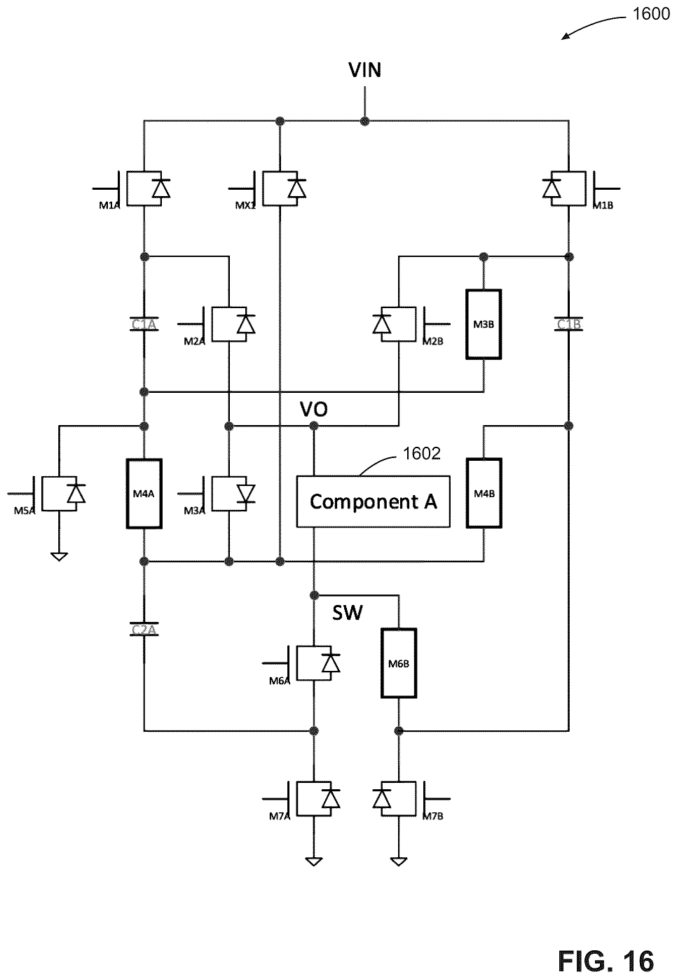

FIG. 16 is a circuit diagram of a hybrid DC-DC converter 1600. Hybrid DC-DC converter 1600 is essentially hybrid DC-DC converter 800, with inductor L4 replaced by magnetic reactive component A 1602. The functionality of hybrid DC-DC converter 1600 (e.g., performance parameters such as current paths, voltages, etc.) is similar to that of hybrid DC-DC converter 800. In an aspect, magnetic reactive component A 1602 is any of a transformer, a coupled inductor, or a TLVR inductor, configured to enhance a load transient response of a load connected to output node VO of hybrid DC-DC converter 1600. The output node VO of hybrid DC-DC converter 1600 may be associated with an output voltage Vₒᵤₜ.

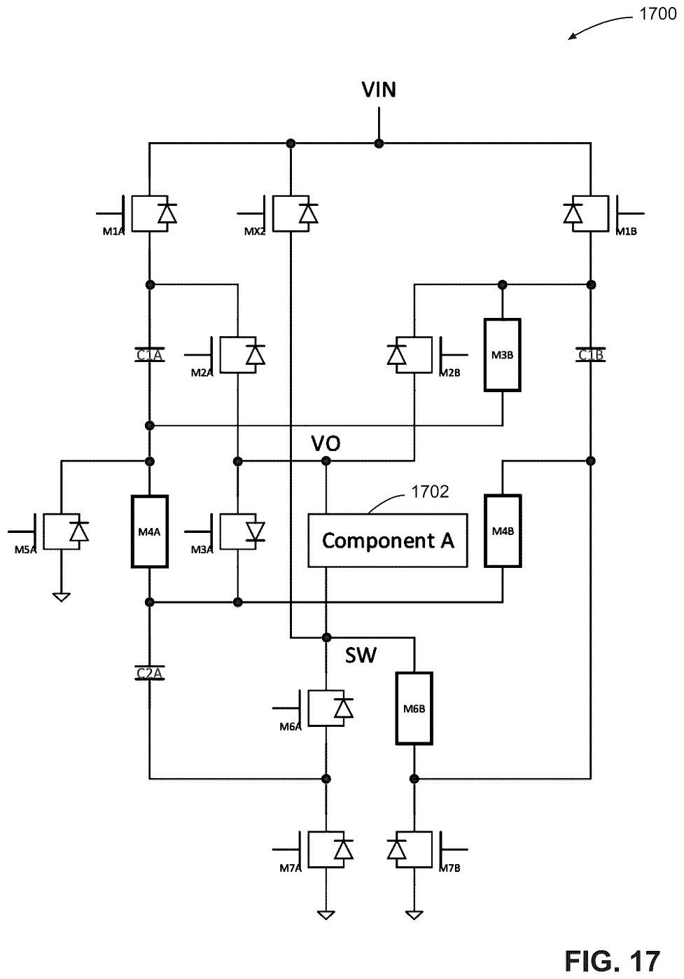

FIG. 17 is a circuit diagram of a hybrid DC-DC converter 1700. Hybrid DC-DC converter 1700 is essentially hybrid DC-DC converter 900, with inductor L4 replaced by magnetic reactive component A 1702. The functionality of hybrid DC-DC converter 1700 (e.g., performance parameters such as current paths, voltages, etc.) is similar to that of hybrid DC-DC converter 900. In an aspect, magnetic reactive component A 1702 is any of a transformer, a coupled inductor, or a TLVR inductor, configured to enhance a load transient response of a load connected to output node VO of hybrid DC-DC converter 1700. The output node VO of hybrid DC-DC converter 1700 may be associated with an output voltage Vₒᵤₜ.

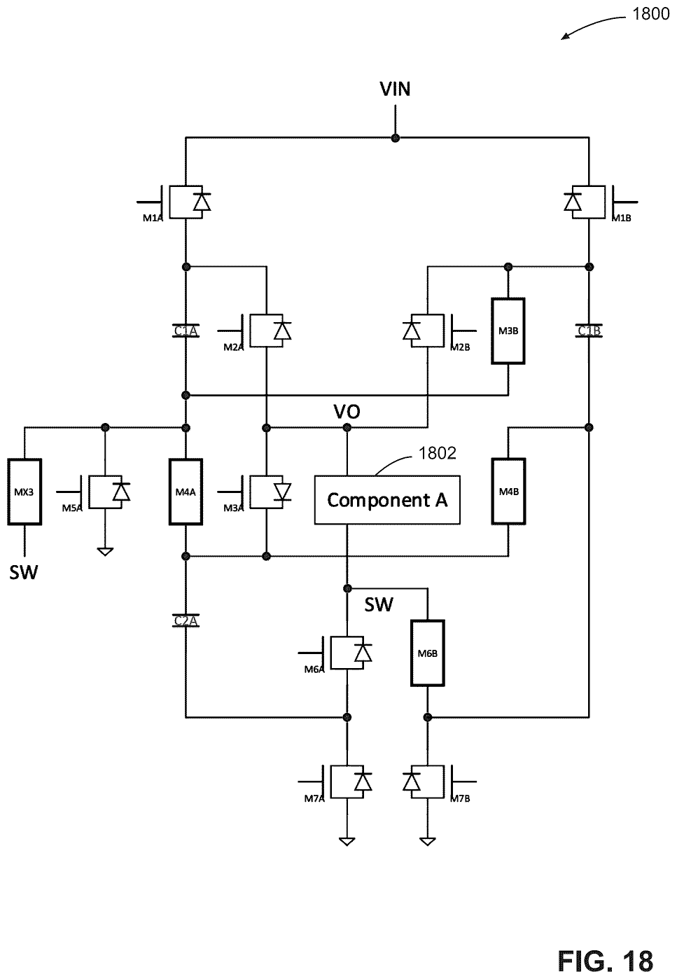

FIG. 18 is a circuit diagram of a hybrid DC-DC converter 1800. Hybrid DC-DC converter 1800 is essentially hybrid DC-DC converter 1000, with inductor L4 replaced by magnetic reactive component A 1802. The functionality of hybrid DC-DC converter 1800 (e.g., performance parameters such as current paths, voltages, etc.) is similar to that of hybrid DC-DC converter 1000. In an aspect, magnetic reactive component A 1802 is any of a transformer, a coupled inductor, or a TLVR inductor, configured to enhance a load transient response of a load connected to output node VO of hybrid DC-DC converter 1800. The output node VO of hybrid DC-DC converter 1800 may be associated with an output voltage Vₒᵤₜ.

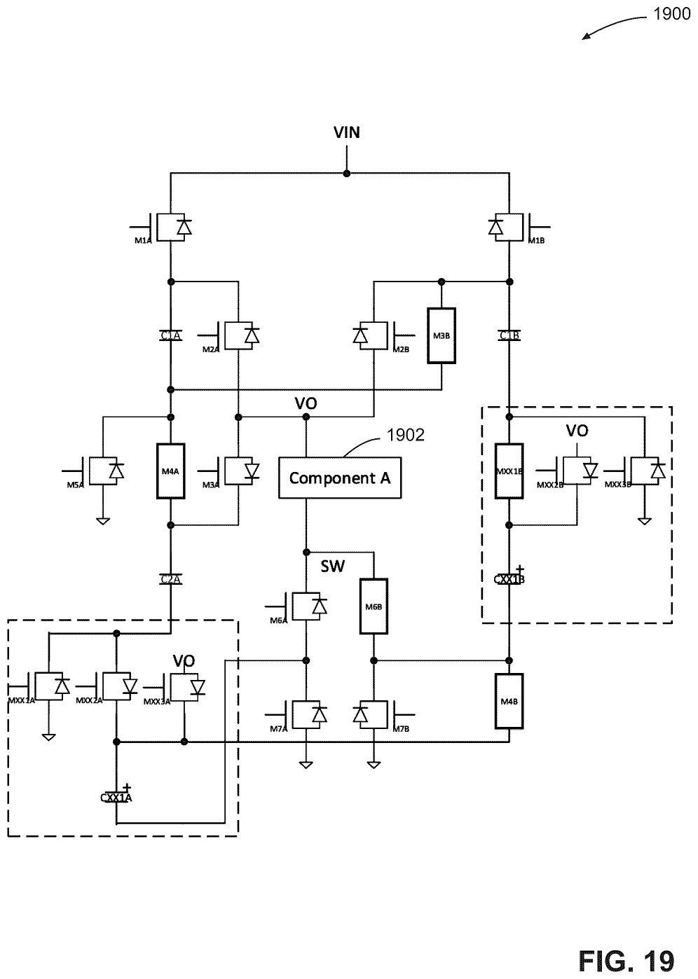

FIG. 19 is a circuit diagram of a hybrid DC-DC converter 1900. Hybrid DC-DC converter 1900 is essentially hybrid DC-DC converter 1100, with inductor L4 replaced by magnetic reactive component A 1902. The functionality of hybrid DC-DC converter 1900 (e.g., performance parameters such as current paths, voltages, etc.) is similar to that of hybrid DC-DC converter 1100. In an aspect, magnetic reactive component A 1902 is any of a transformer, a coupled inductor, or a TLVR inductor, configured to enhance a load transient response of a load connected to output node VO of hybrid DC-DC converter 1900. The output node VO of hybrid DC-DC converter 1900 may be associated with an output voltage Vₒᵤₜ.

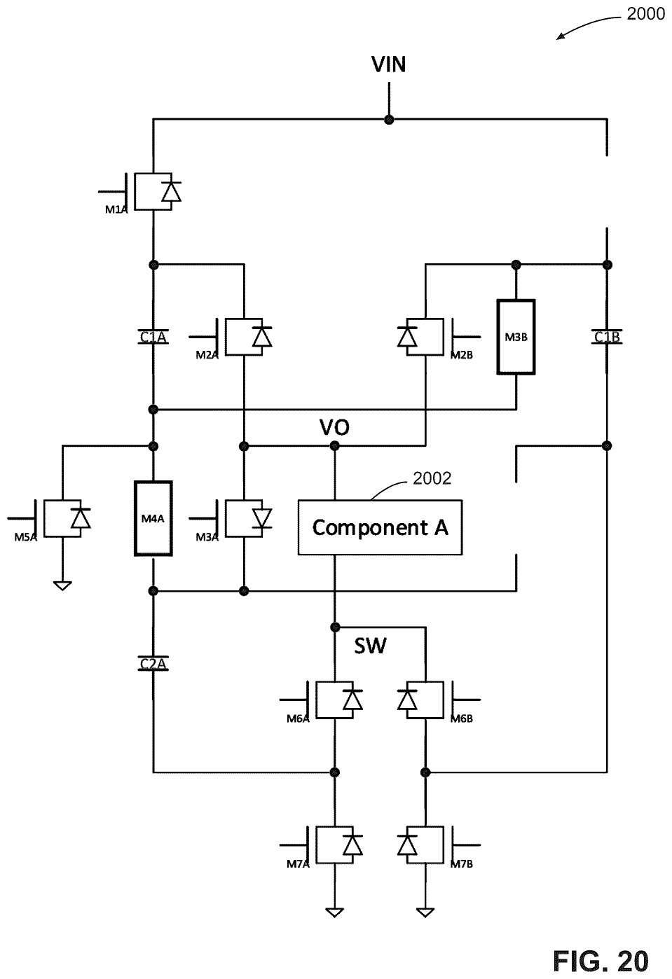

FIG. 20 is a circuit diagram of a hybrid DC-DC converter 2000. Hybrid DC-DC converter 2000 is essentially hybrid DC-DC converter 1200, with inductor L4 replaced by magnetic reactive component A 2002. The functionality of hybrid DC-DC converter 2000 (e.g., performance parameters such as current paths, voltages, etc.) is similar to that of hybrid DC-DC converter 1200. In an aspect, magnetic reactive component A 2002 is any of a transformer, a coupled inductor, or a TLVR inductor, configured to enhance a load transient response of a load connected to output node VO of hybrid DC-DC converter 2000. The output node VO of hybrid DC-DC converter 2000 may be associated with an output voltage Vₒᵤₜ.

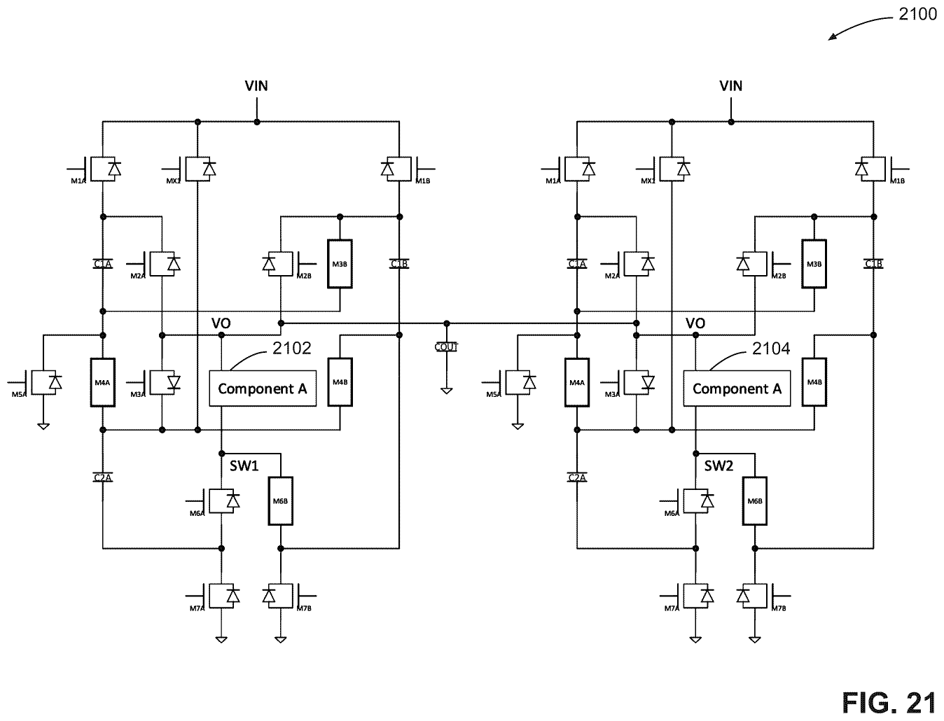

FIG. 21 is a circuit diagram depicting a pair of parallel-connected hybrid DC-DC converters 2100. The circuit topology of parallel-connected hybrid DC-DC converters 2100 is essentially the parallel hybrid DC-DC converter connection topology 1400, with inductors L1 and L2 replaced by magnetic reactive component A 2102 and magnetic reactive component A 2104, respectively. The functionality of parallel-connected hybrid DC-DC converters 2100 (e.g., performance parameters such as current paths, voltages, etc.) is similar to that of parallel-connected hybrid DC-DC converters 1400. In an aspect, each of magnetic reactive component A 2102 and magnetic reactive component A 2104 is any of a transformer, a coupled inductor, or a TLVR inductor, configured to enhance a load transient response of a load connected to output node VO of the respective hybrid DC-DC converter included in the circuit topology 2100. The load transient response enhancement may be achieved due to magnetic coupling between magnetic reactive component A 2102 and magnetic reactive component A 2104.

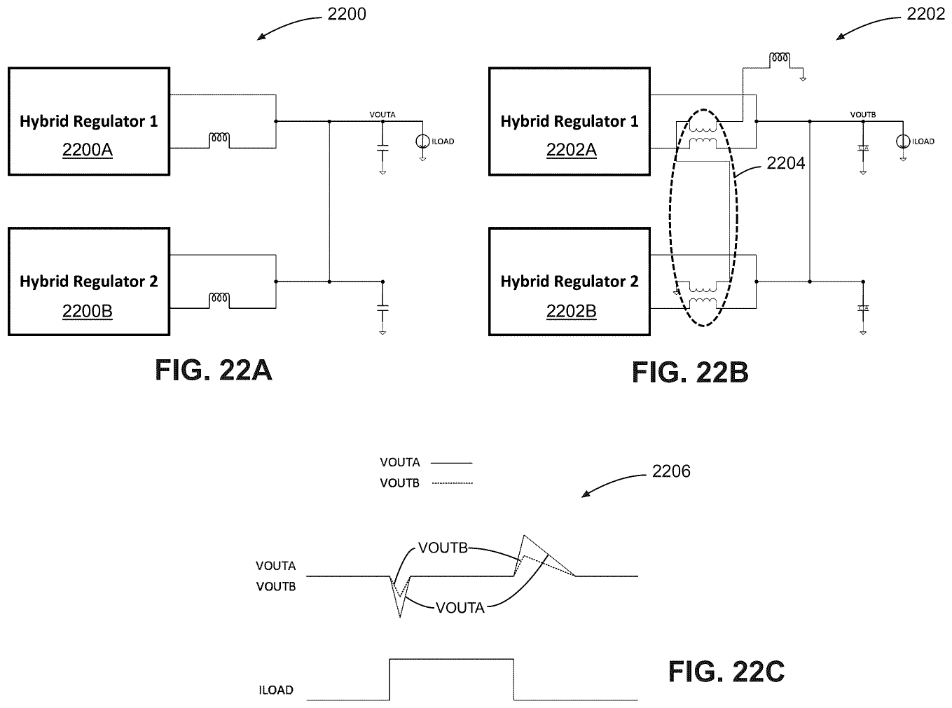

FIG. 22A is a circuit diagram depicting a hybrid regulator connection topology 2200. As depicted, hybrid regulator connection topology 2200 includes hybrid regulator 1 2200A and hybrid regulator 2 2200B, in a connection topology similar to parallel-connected hybrid DC-DC converters 1400. Each of hybrid regulator 2200A and 2200B may be similar to any of the hybrid DC-DC converters described herein. In this topology, there is no magnetic coupling between the respective inductors of hybrid regulator A 2200A and hybrid regulator B 2200B. In the topology 2200, there is no magnetic coupling-derived load transient response enhancement associated with the output voltage VOUTA associated with topology 2200.

FIG. 22B is a circuit diagram depicting a hybrid regulator connection topology 2202. As depicted, hybrid regulator connection topology 2202 includes hybrid regulator 1 2202A and hybrid regulator 2 2202B, in a connection topology similar to parallel-connected hybrid DC-DC converters 2100. Each of hybrid regulator 2202A and 2202B may be similar to any of the hybrid DC-DC converters described herein. In this topology, there exists magnetic coupling 2204 between the respective magnetic reactive components of hybrid regulator A 2202A and hybrid regulator B 2202B. In the topology 2202, there is magnetic coupling-derived load transient response enhancement associated with the output voltage VOUTB associated with topology 2202.

FIG. 22C is a waveform diagram 2206 presenting load voltage transient response and load current waveforms. For a given load current ILOAD profile, the load voltage VOUTB associated with hybrid regulator connection topology 2202 shows a better transient response (e.g., smaller transient rise time and transient settling time, and lower peak transient voltage) as comparted to the transient response of the load voltage VOUT A associated with hybrid regulator connection topology 2200. Waveform diagram 2206 shows how magnetic coupling enhances the load transient response of hybrid DC-DC converter topologies.

Hybrid DC-DC converter topologies 100 and 800-1200 may be configured such that the respective magnetic reactive component A is magnetically coupled with a magnetic reactive component A of another hybrid DC-DC converter (e.g., a hybrid DC-DC converter with a topology similar to 100 and 800-1200). Due to this coupling, the load transient response associated with the respective load may be enhanced.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. An electrical circuit configured to perform a DC-DC voltage conversion between an input voltage Vᵢₙ and an output voltage Vₒᵤₜ, the electrical circuit comprising:
a first electrical network that includes seven switching transistors and two flying capacitors;
a second electrical network that includes six switching transistors and one flying capacitor, wherein the first electrical network and the second electrical network are interconnected at least at each of an input node associated with the input voltage, an output node associated with the output voltage, and a switching node, and wherein two switching transistors of the six switching transistors in the second electrical network further connect the first electrical network and the second electrical network; and
a magnetic reactive component connected between the switching node and the output node, wherein the DC-DC voltage conversion involves a repeating cycle of six distinct switching system states, and wherein each switching system state is associated with a distinct electric current path through the electrical circuit.

2. The electrical circuit of claim 1, wherein:
the magnetic reactive component is included in a current path from the input node to the output node;
a direct path between the input node and the output node includes at least one switching transistor;
any current path between the input node and the switching node includes at least one flying capacitor of the flying capacitors; and
there is at least one switching transistor connected directly to the output node.

3. The electrical circuit of claim 1, wherein the six distinct switching system states are comprised of a first magnetization system state, a demagnetization system state, a second magnetization system state, the demagnetization system state, a third magnetization system state, and the demagnetization system state.

4. The electrical circuit of claim 1, wherein at the end of the sixth switching system state, a voltage on each flying capacitor is substantially equal to a voltage on the respective flying capacitor at a beginning of the first system state.

5. The electrical circuit of claim 4, wherein the equality is established by a feedback control circuit.

6. The electrical circuit of claim 1, wherein each system state is associated with a combination of each of the switching transistors being either in an on state or an off state.

7. The electrical circuit of claim 1, wherein the input voltage and the output voltage are related as Vᵢₙ≥3Vₒᵤₜ.

8. The electrical circuit of claim 1, wherein any combination of the first electrical network and the second electrical network includes any combination of one or more switching transistors to provide a modified electrical circuit, wherein the input voltage and the output voltage for the modified electrical circuit are related as Vᵢₙ≥Vₒᵤₜ.

9. The electrical circuit of claim 1, further comprising a parallel connection of a plurality of electrical circuits to provide a modified electrical circuit configured to further provide a higher electric current to a load as compared an electric current provided by the electrical circuit operating singularly.

10. The electrical circuit of claim 1, wherein a transition between any switching system state and a subsequent switching system state is governed by a clock signal.

11. The electrical circuit of claim 1, wherein at least one switching transistor in either the first electrical network or the second electrical network is a power switch with reverse blocking.

12. The electrical circuit of claim 1, wherein the electrical circuit supports a mode of operation characterized by an inequality Vᵢₙ>3Vₒᵤₜ.

13. The electrical circuit of claim 1, further comprising a modified electrical circuit that includes at least one switching transistor added to the electrical circuit.

14. The modified electrical circuit of claim 13, wherein the modified electrical circuit is supports a mode of operation characterized by one of the following inequalities:
$$3 {V}_{out} \geq {V}_{in} \geq 2 {V}_{out} ;$$
$$2 {V}_{out} \geq {V}_{in} \geq {V}_{out} ;$$
$${V}_{in} > {V}_{out} ; and$$
$${V}_{in} \geq 4 {V}_{out} .$$

15. The electrical circuit of claim 1, wherein the magnetic reactive component is an inductor.

16. The electrical circuit of claim 1, wherein the magnetic reactive component is any of a transformer, a coupled inductor, or a TLVR inductor configured to enhance a load transient response of a load connected to the output node.

17. An electrical circuit configured to perform a DC-DC voltage conversion between an input voltage Vᵢₙ and an output voltage Vₒᵤₜ, the electrical circuit comprising:
a first electrical network that includes seven switching transistors and two flying capacitors;
a second electrical network that includes four switching transistors and one flying capacitor, wherein the first electrical network and the second electrical network are interconnected at least at each of an input node associated with the input voltage, an output node associated with the output voltage, and a switching node, and wherein two switching transistors of the four switching transistors in the second electrical network further connect the first electrical network and the second electrical network; and
a magnetic reactive component connected between the switching node and the output node, wherein the DC-DC voltage conversion involves a repeating cycle of four distinct switching system states, and wherein each switching system state is associated with a distinct electric current path through the electrical circuit.

18. The electrical circuit of claim 17, wherein:
the magnetic reactive component is included in a current path from the input node to the output node;
a direct path between the input node and the output node includes at least one switching transistor;
any current path between the input node and the switching node includes at least one flying capacitor of the flying capacitors; and
there is at least one switching transistor connected directly to the output node.

19. The electrical circuit of claim 17, wherein the four distinct switching system states are comprised of a first magnetization system state, a demagnetization system state, a second magnetization system state, and the demagnetization system state.

20. The electrical circuit of claim 17, wherein at the end of the fourth switching system state, a voltage on each flying capacitor is substantially equal to a voltage on the respective flying capacitor at a beginning of the first system state.

21. The electrical circuit of claim 20, wherein the equality is established by a feedback control circuit.

22. The electrical circuit of claim 17, wherein each system state is associated with a combination of each of the switching transistors being either in an on state or an off state.

23. The electrical circuit of claim 17, wherein the input voltage and the output voltage are related as Vᵢₙ≥3Vₒᵤₜ.

24. The electrical circuit of claim 17, wherein any combination of the first electrical network and the second electrical network includes any combination of one or more switching transistors to provide a modified electrical circuit, wherein the input voltage and the output voltage for the modified electrical circuit are related as Vᵢₙ≥Vₒᵤₜ.

25. The electrical circuit of claim 17, further comprising a parallel connection of a plurality of electrical circuits to provide a modified electrical circuit configured to further provide a higher electric current to a load as compared an electric current provided by the electrical circuit operating singularly.

26. The electrical circuit of claim 17, wherein a transition between any switching system state and a subsequent switching system state is governed by a clock signal.

27. The electrical circuit of claim 17, wherein at least one switching transistor in either the first electrical network or the second electrical network is a power switch with reverse blocking.

28. The electrical circuit of claim 17, wherein the magnetic reactive component is an inductor.

29. The electrical circuit of claim 17, wherein the magnetic reactive component is any of a transformer, a coupled inductor, or a TLVR inductor configured to enhance a load transient response of a load connected to the output node.
